(19) United States
(12) Patent Application Publication
(10) Pub. No.: US 2016/0286045 A1
(43) Pub. Date: Sep. 29, 2016

(54) SYSTEM AND METHOD FOR PROVIDING AN INFORMATIVE MESSAGE WHEN REJECTING AN INCOMING CALL

(71) Applicant: VONAGE NETWORK LLC, Holmdel, NJ (US)

(72) Inventors: Natan Shaltiel, Tel-Aviv (IL); Sagi Dudai, Tel-Aviv (IL)

(21) Appl. No.: 14/665,326

(22) Filed: Mar. 23, 2015

(51) Int. Cl. H04M 3/48; H04W 4/02; H04M 1/725; H04M 1/00

(52) U.S. Cl. CPC H04M 3/48; H04M 1/006; H04W 4/025; H04M 1/72566

(57) ABSTRACT

Methods and systems for providing an informative message when rejecting an incoming call are provided herein. In some embodiments, a method for providing an informative message when rejecting an incoming call comprises receiving a request to reject an incoming call with a message; generating a plurality of messages based on status information; receiving a selection of one of the plurality of generated messages; and setting a reminder to notify the user of a callback, wherein the reminder is based on the selected message.

### BACKGROUND

1. Field

Embodiments of the present invention generally relate to systems and methods for providing an informative message when rejecting an incoming call.

2. Description of the Related Art

Oftentimes, a user of a mobile device receives an incoming telephone call when the user is for example, in a meeting, driving, watching television, or is simply unable to take the call. Currently, the incoming call may be rejected with a message. However, the message that is sent when rejecting the call is predefined or alternatively, requires a user to manually enter text in order to provide a customized message. The predefined messages may not convey enough information to the incoming caller and the customized messages require time of the user.

Thus, there is a need for providing an informative message when rejecting an incoming call.

### SUMMARY

Methods and systems for providing an informative message when rejecting an incoming call are provided herein. In some embodiments, a method for providing an informative message when rejecting an incoming call comprises receiving a request to reject an incoming call with a message; generating a plurality of messages based on status information; receiving a selection of one of the plurality of generated messages; and setting a reminder to notify the user of a callback, wherein the reminder is based on the selected message.

In some embodiments, a system for providing an informative message when rejecting an incoming call may include a message generation module configured to generate a plurality of messages based on status information; a reminder module configured to receive a selection of one of the plurality of generated messages and set a reminder to notify the user of a callback, wherein the reminder is based on the selected message; and a communication module configured to transmit the selected message to a device where the incoming call originated.

In some embodiments, a non-transitory computer readable medium for providing an informative message when rejecting an incoming call is disclosed. The computer readable medium stores computer instructions that, when executed by at least one processor causes the at least one processor to perform the method for providing an informative message when rejecting an incoming call.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 a block diagram of various elements of a processor that forms part of an IP telephony system, in accordance with one or more embodiments of the invention;

FIG. 3 illustrates some of the elements that are present in a mobile device, according to one or more embodiments of the invention; and

FIG. 4 depicts a flow diagram of a method for providing an informative message when rejecting an incoming call, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to systems and methods for providing an informative message when rejecting an incoming call. More specifically, embodiments of the present invention generate a plurality of messages such that one of the messages may be selected and sent to an incoming caller when a user rejects an incoming call. The messages are generated based on a user's location, a time of day, whether the user is driving, and the like, and provide meaningful information to the incoming caller about the user's current status and/or when to expect a call back. When one of the plurality of messages is selected by a user, the message is sent to the device of the incoming caller and a reminder is set to remind the user to return the call at a time based on the selected message.

Some portions of the detailed description that follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

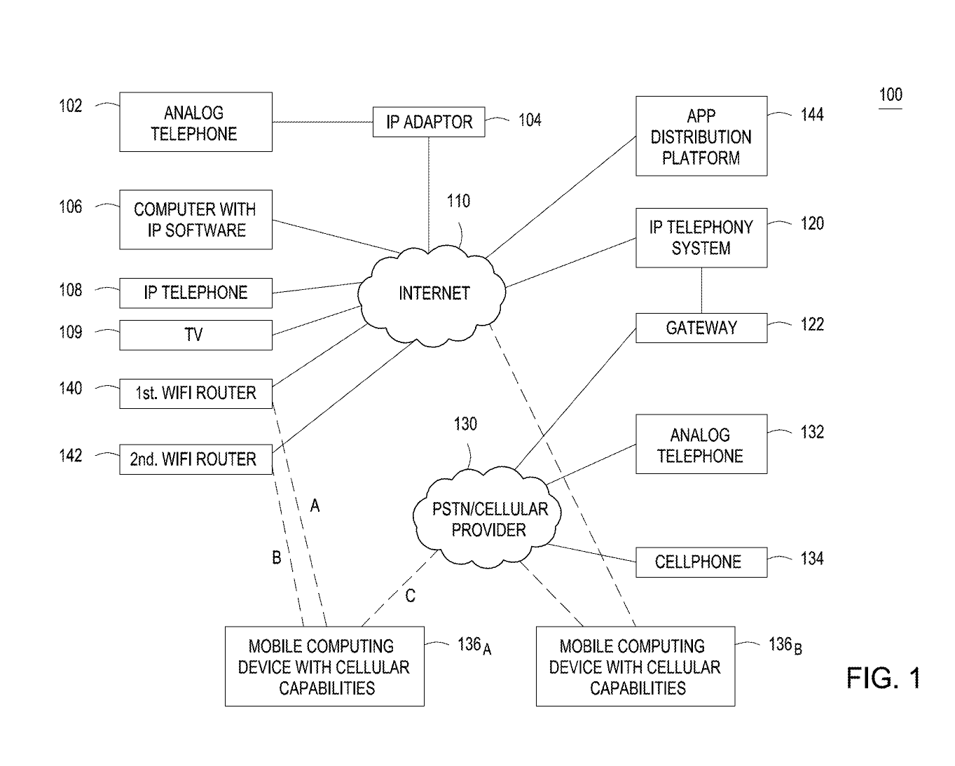

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may be provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a wireless local area network (WLAN) router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the wireless local area network (WLAN) based on the Institute of Electrical and Electronics Engineers' (IEEE) 802.11 and 802.13 standards.

Similarly, mobile computing device with cellular capabilities 136B may also be coupled to internet 110 and/or cellular service provider 130. In some embodiments, mobile computing device 136B may be connected to internet 110 via a wireless local area network (WLAN) based on the Institute of Electrical and Electronics Engineers' (IEEE) 802.11 and 802.13 standard connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

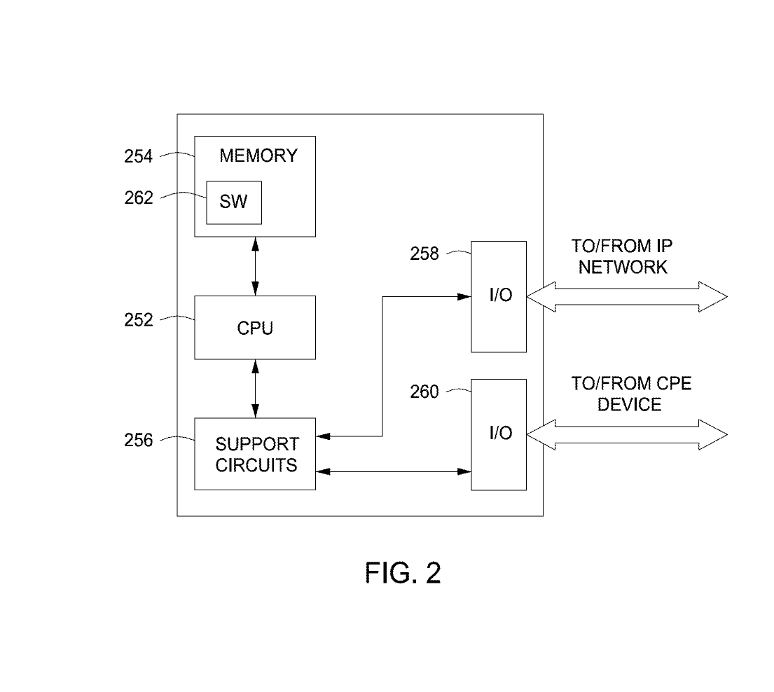

FIG. 2 illustrates elements of a computer processor 250 that can be used as part of the IP telephony system 120 to accomplish various functions. The IP telephony system 120 could include multiple processors 250 located at various locations in the system, along with their operating components and programming, each carrying out a specific or dedicated portion of the functions performed by the VoIP based telephony service 120. Further, a mobile telephony device 136 or some other IP telephony device could make use of one or more of the processors 250 to accomplish various functions.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment and to service provider agent equipment, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120, or a mobile telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture

The following description refers to IP telephony communications, or simply telephony communications. This phrase is intended to encompass any type of communication, including voice or video telephone calls, text messages and other forms of text-based, voice-based, or video-based messaging, as well as other forms of communications. Although the following examples may refer to a “call” or a “telephone call,” for ease of reference, clarity and brevity, the systems and methods described may also be used to accomplish other forms of communications.

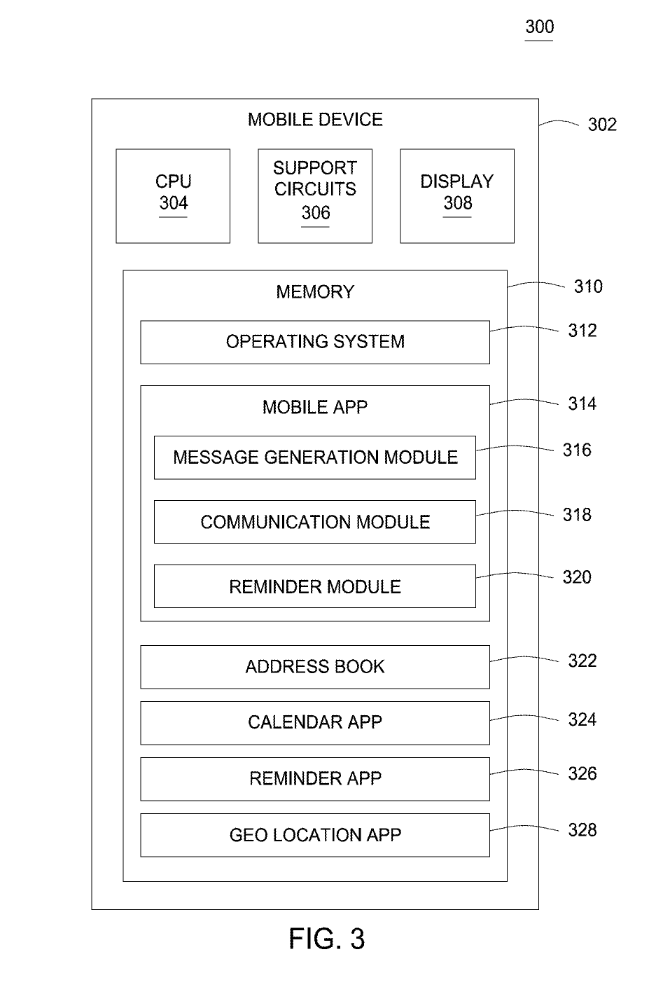

FIG. 3 illustrates some of the elements that are present in a mobile device 302, according to one or more embodiments of the present invention. The mobile device 300 may include a computer with IP software 106, IP telephone 108, television 109 (e.g., a Smart TV), and/or mobile computing device with cellular capabilities 136A, 136B, and the like, as shown in FIG. 1. The mobile device 302 comprises a Central Processing Unit (CPU) 304, support circuits 306, display 308, and a memory 310. The CPU 304 may comprise one or more commercially available microprocessors or microcontrollers that facilitate data processing and storage. The various support circuits 306 facilitate the operation of the CPU 304 and include one or more clock circuits, power supplies, cache, input/output circuits, and the like. The memory 310 comprises at least one of Read Only Memory (ROM), Random Access Memory (RAM), disk drive storage, optical storage, removable storage and/or the like. In some embodiments, the memory 310 comprises an operating system 310, a mobile application 314, an address book 322, a calendar app 324, a reminder app 326, and a geo-location module 328.

The operating system (OS) 312 generally manages various computer resources (e.g., network resources, file processors, and/or the like). The operating system 312 is configured to execute operations on one or more hardware and/or software modules, such as Network Interface Cards (NICs), hard disks, virtualization layers, firewalls and/or the like. Examples of the operating system 312 may include, but are not limited to, LINUX, MAC OSX, BSD, UNIX, MICROSOFT WINDOWS, 10S, ANDROID and the like. In some embodiments, operating system 312 may include an application programming interface (API) which can be used to access user device information and features (such as, for example, by mobile app 314).

The geo-location module 328 determines a location of a device, such as mobile device 302. The location of the device may be determined using Global Positioning Satellite (GPS) equipment and information, WiFi triangulations, cell tower ID, Near Field Communication (NFC), and the like. In some embodiments, the geo-location module 328 may be built into the mobile device 302 or may be externally attached and communicatively coupled to the mobile device 302 (e.g., attached to a mobile phone). The reminder module 320 requests location information and in some instances, requests a geo-fence to be created around a specific location. The location information and geo-fence are obtained from the geo-location module 328 using application programming interface (API) calls to the geo-location module 328. The reminder module 320 may request that the geo-fence is a created by specifying a location using, for example GPS coordinates and a distance around said location, for example 50 meters. The geo-location module 328 sets a perimeter around the specified location, such that when the geo-fence is breached, the geo-location module 328 notifies the reminder module 320 of the breach.

The mobile application 314 may include a message generation module 316, a communication module 318, and a reminder module 320. In some embodiments, the mobile application 314 may be an over-the-top (OTT) telecommunication application. The message generation module 316 is configured to generate a plurality of messages based on the user's location, the rate at which the user's location is changing, a time of day, and the like. The communication module 318 sends a selected one of the plurality of messages to the incoming caller. The reminder module 320 reminds the user to return the call at an appropriate time based on the selected message.

When an incoming call is rejected, the message generation module 316 accesses the user's calendar to determine a status of the user. For example, the calendar may indicate that a user is in a meeting, at an appointment, in a movie, or otherwise disposed and unable to accept a call. The message generation module 316 queries the calendar app 324 for all events on the calendar for the current day. The events are obtained from the calendar app 324 using application programming interface (API) calls by the mobile app 314. If the current time overlaps with a scheduled event in the calendar, the message generation module 316 determines the next available timeslot on the calendar. For example, if the current time is 2:15 pm and the user is scheduled in a meeting from 2:00 pm-3:00 pm and is also scheduled in a meeting from 3:00 pm-4:00 pm, the message generation module 316 may generate a message that reads, for example, “I'm in a meeting. I will call you back after 4:00 pm.” In some embodiments, if the user were to select this message, a reminder is set for the next available timeslot on the calendar; in the present example, 4:00 pm. In some embodiments, a reminder is set for a preconfigured amount of time after the last event was scheduled to end (e.g., 15 minutes after the last event was scheduled to end). In some embodiments, a reminder is set for the next available timeslot; however the time may be modified by the user by, for example, scrolling to another time. In some embodiments, the reminder may be a pop-up dialog box that includes a button/option to initiate the call back using the mobile app 314. In some embodiments, a call may be automatically initiated at that time. In some embodiments, the reminder may be a text message with a link to the callback number. In some embodiments, the reminder may be a PUSH notification. The message may be any message type known in the art that may be sent to the user as a reminder.

In some embodiments, a user's location may be used to generate informative messages. The message generation module 316 accesses a user's address book 322 to determine whether the user has a contact in the address book 322 that includes for example, the user's name, “Home”, or the like. If the contact exists, an address may be extracted from the address book 322. The address is obtained from the address book 322 using application programming interface (API) calls by the message generation module 316. The address is input into the geo-location module 328. The location determined for the input address is compared to the location of the user, for example using location information determined by the geo-location module 328 (via API calls as described above). If the location of address in the address book 322 matches the location of the user's device, the message generation module 316 may generate a message that reads for example, “I'll call you back when I leave home” or “I'll call you when I get to the office.” Alternatively, if the user has a contact in an address book 322 for “Office” or “Work”, the location is extracted from the address book 322 and the location of the address is compared to the user's current location. A message may be generated, such as “I'll call you back when I leave the office” or “I'll call you back when I get home”. If one of these messages is selected, the reminder module 320 sends a request to the geo-location module 328 to set a geo-fence around the location, such that when the geo-fence is breached, the geo-location module 328 sends a message to the reminder module 320, which in turn sends a reminder to the user. If no entry exists in the address book for home or office, both messages, for example, “I'll call you when I get home” and I'll call you when I get to the office” may be generated. If one of these messages is selected, when the user places the return call, the geo-location module 328 infers the location of the user (e.g., home or office). In some embodiments, an entry may be automatically generated and saved into the address book 322 with the determined address. In some embodiments, an option is displayed to the user to save the location in the address book as “home” or “office”.

Other generic messages may be generated, such as “I'll call you back in X minutes”, where X may be preconfigured by the user or selected by scrolling to a desired number of minutes. If selected, a reminder is set for the specified number of minutes. A user may be engaged with their mobile device, for example, watching a video or reading an email. If an incoming call is rejected, a message may be generated that reads, “I'll call back soon.” If this message is selected, when the phone locks, a reminder is triggered to call back the caller.

The geo-location module 328 monitors a user's location at predefined intervals, for example every three seconds. If it is detected that the user location changes by a minimum threshold over a predefined interval, it is assumed that the user is driving. In such case, a message may be generated that reads, “I'm driving. I'll call you back when I'm stopped.” If this message is selected, the geo-location module 328 continues to monitor the location of the user and when the user's location is no longer changing, it is assumed the user has stopped driving and a reminder is sent to user. Similarly, if the user is not moving, a message may be generated to read, “I'll call you back from the road.” The geo-location module 328 continues to monitor the location of the user. When it is determined that the user has reached a speed of, for example, 15 mph (i.e., the user's location changes by a minimum threshold over a predefined interval) a reminder is sent.

If the incoming caller is in the user's address book, the caller's address may be extracted from the address book 322. The caller's address is input into the geo-location module 328, which, using APIs identifies a distance to the incoming caller's location and/or an arrival time at the incoming caller's location. As such, one or more messages may be generated that read, for example, “I'll be at your place in 10 minutes” and “I am 5 miles from you.”

If a user has a smart television, or a television with a media streaming device attached (e.g., GOOGLE CHROMECAST, AMAZON FIRE TV, ROKU, etc.), in their house, a link can be created between the communication module 318 of mobile device 302 and an app on the smart television or the media streaming device. The link may be established over a wireless local area network (WLAN) based on the Institute of Electrical and Electronics Engineers' (IEEE) 802.11 and 802.13 standard connection. When an incoming call is rejected, the mobile app 314 requests the current data on the television from the app on the smart television or the media streaming device. For example, the mobile app 314 may request programming information from the app on the smart television to determine when the user's program is ending such that the message generation module 316 may generate a message that reads, for example “I'm watching a movie. I will call you in 40 minutes” or “I will call you back during the next commercial break”. If this message is selected, a reminder is set to callback the caller in 40 minutes, or at the beginning of the next commercial break, as appropriate.

Upon selection of a generated message, the communication module 318 sends the message to the device of the incoming caller. The message may be a session initiation protocol (SIP) message, such as a SIP NOTIFY. The details and functionality of SIP can be found in the Internet Engineering Task Force (IETF) Request for Comments (RFC) Paper No. 3261 entitled, “SIP: Session Initiation Protocol,” that is herein incorporated in its entirety by reference. In some embodiments, the message may be a short message service (SMS) message or sent via any messaging protocol. In some embodiments, the reminder module 320 sets a reminder using an API that accesses reminders or calendars on the mobile device 302. When the time arrives, the reminder module 320 notifies the user. In some embodiments, the reminder module 320 sets a countdown timer, such that when the timer counts down to zero, the reminder module 320 notifies the user. However, various methods for setting reminders as known in the art may be used.

An order of selectable messages that are displayed on display 308 may be prioritized based on, for example, a time of day, a location, whether the user driving, and the like. For example, if it is between 6 am and 9 am, messages about driving to the office may be displayed before messages about driving home. During work hours, for example 9 am-5 pm, messages about being in a meeting are displayed before messages about watching television. If the location of the user is not changing significantly, the messages about driving may be displayed below more relevant messages, and the like.

The information used to generate the plurality of messages may be ambiguous and therefore indicate a plurality of possible circumstances. Therefore, a plurality of possible messages may be generated for selection by the user.

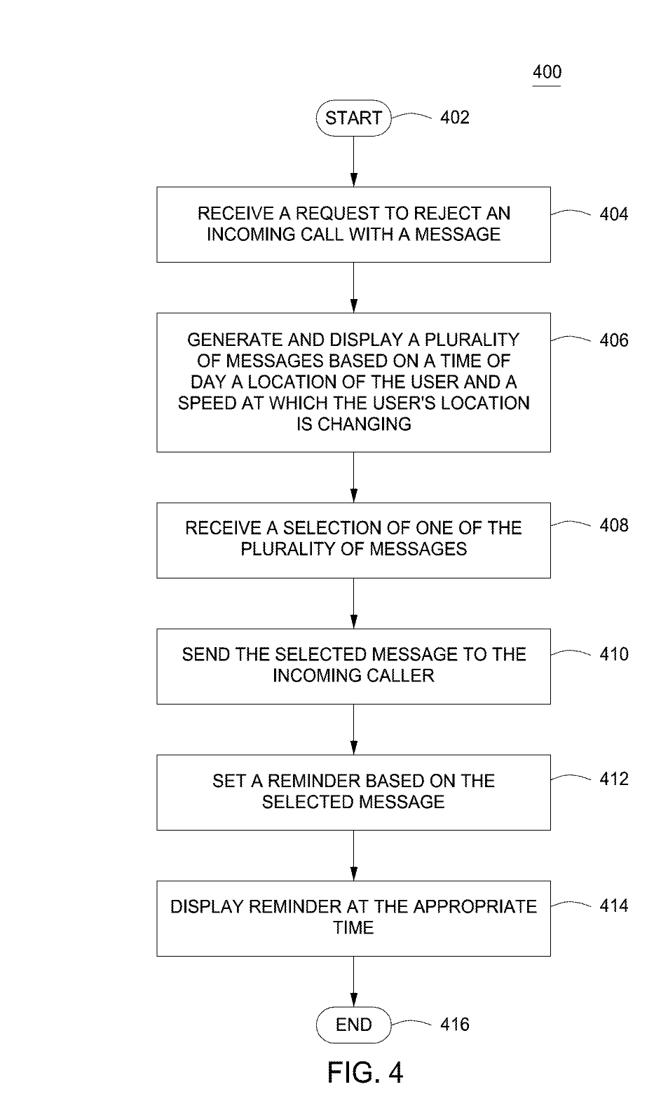

FIG. 4 depicts a flow diagram of a method 400 for providing an informative message when rejecting an incoming call, according to one or more embodiments of the invention. The method 400 starts at step 402 and proceeds to step 404.

At step 404, a request is received by the mobile application 314 to reject an incoming call with a message. At step 406, a plurality of messages are generated and displayed. The messages are generated based on a time of day, a location of a user, a determination of whether the user is driving, a determination of whether the user is otherwise engaged with their mobile device, and the like as described above. The generated messages are displayed in an order such that a message that more likely may be selected is displayed before a message that is less likely to be selected based on the time of day, location, etc.

At step 408, a selection of a message is received. At step 410, the message is transmitted to the incoming caller's device. In some embodiments, the message may be a session initiation protocol (SIP) message, such as a SIP NOTIFY. In some embodiments, the message may be an SMS message.

At step 412, a reminder is set. If the selected message indicated a specific time when the call would be returned, a reminder is set for that time. If the message caused a geo-fence to be set around a location, the geo-fence is monitored for a breach. If the message indicated a number of minutes when the call would be returned, a countdown time may be set.

At step 414, the time when the user is to be reminded to return the call is reached and the user is notified. In some embodiments, a message is displayed indicating to whom a return call is scheduled. The message may include a button to initiate the call, for example, “Call now?” In some embodiments, the call is automatically initiated at the time of notification. The method ends at step 416.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example, but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for providing an informative message when rejecting an incoming call on a user device, comprising:
receiving a request to reject an incoming call with a message;
generating a plurality of messages based on status information of a user;
receiving a selection of one of the plurality of generated messages; and
setting a reminder to notify the user of a callback, wherein the reminder is based on the selected message.

2. The method of claim 1, wherein status information is based on at least one of a time of day, a location of a user device, and a speed at which a user device is changing location.

3. The method of claim 1, further comprising transmitting the selected message to a device where the incoming call originated.

4. The method of claim 1, wherein generating one of the plurality of messages comprises:
accessing a calendar of the user;
determining a user is currently scheduled for an event on the calendar wherein determining comprises comparing a current time to a time on the calendar;
identifying a next available timeslot on the calendar; and
generating a message indicating a callback at the next available timeslot.

5. The method of claim 1, wherein generating one of the plurality of messages comprises:
accessing an address book on a device of the user;
determining whether an entry exists in the address book identifying a first address of the user;
determining a location of the first address;
determining a current location of the user; and
generating a message indicating a callback upon leaving the first address when the current location of the user matches the location of the identified first address of the user.

6. The method of claim 1, wherein generating one of the plurality of messages comprises:
monitoring the location of a user device;
determining an indication of a change in speed of the user device when a location of the user device changes by a minimum threshold over a predefined time interval; and
generating a message indicating a callback based on the indication of a change in speed.

7. The method of claim 1, wherein generating one of the plurality of messages comprises:
extracting an address of a caller associated with the incoming call from an address book;
determining a location of a user device; and
generating a message indicating an estimated arrival time to the location of the caller based on the extracted address of the caller and the determined location of the user device.

8. The method of claim 1, wherein generating one of the plurality of messages comprises:
linking a mobile app on a user device to an app on a smart television;
notifying the app on the smart television of an incoming call on the user device;
requesting programming data from the app on the smart television; and
generating a message indicating a callback at a time when a current program is ended.

9. The method of claim 1, wherein the reminder comprises one of setting a reminder on one of a reminder app or a calendar app, setting a geo-fence around a specified location, or setting a countdown time to the time of notification.

10. The method of claim 1, further comprising displaying the generated plurality of messages in an order prioritized based on a time of day, a location of the user, and a speed at which the location of the user is changing.

11. A system for providing an informative message when rejecting an incoming call on a user device, comprising:
a message generation module configured to generate a plurality of messages based on status information of a user;
a reminder module configured to receive a selection of one of the plurality of generated messages and set a reminder to notify the user of a callback, wherein the reminder is based on the selected message; and
a communication module configured to transmit the selected message to a device where the incoming call originated.

12. The system of claim 11, wherein status information is based on at least one of a time of day, a location of a user device, and a speed at which a user device is changing location.

13. The system of claim 11, wherein generating one of the plurality of messages comprises:
accessing a calendar of the user;
determining a user is currently scheduled for an event on the calendar wherein determining comprises comparing a current time to a time on the calendar;
identifying a next available timeslot on the calendar; and
generating a message indicating a callback at the next available timeslot.

14. The system of claim 11, wherein generating one of the plurality of messages comprises:
accessing an address book on the device of the user;
determining whether an entry exists in the address book identifying a first address of the user;
determining a location of the first address;
determining a current location of the user; and
generating a message indicating a callback upon leaving the first address when the current location of the user matches the location of the identified first address of the user.

15. The system of claim 11, wherein generating one of the plurality of messages comprises:
monitoring the location of a user device;
determining an indication of a change in speed of the user device when a location of the user device changes by a minimum threshold over a predefined time interval; and
generating a message indicating a callback based on the indication of a change in speed.

16. The system of claim 11, wherein generating one of the plurality of messages comprises:
extracting an address of a caller associated with the incoming call from an address book;
determining a location of a user device; and
generating a message indicating an estimated arrival time to the location of the caller based on the extracted address of the caller and the determined location of the user device.

17. The system of claim 11, wherein generating one of the plurality of messages comprises:
linking a mobile app on a user device to an app on a smart television;
notifying the app on the smart television of an incoming call on the user device;
requesting programming data from the app on the smart television; and
generating a message indicating a callback at a time when a current program is ended.

18. The system of claim 11, wherein the reminder comprises one of setting a reminder on one of a reminder app or a calendar app, setting a geo-fence around a specified location, or setting a countdown time to the time of notification.

19. A non-transitory computer readable medium for storing computer instructions that, when executed by at least one processor causes the at least one processor to perform a method for providing an informative message when rejecting an incoming call on a user device, comprising:
receiving a request to reject an incoming call with a message;
generating a plurality of messages based status information of a user;
receiving a selection of one of the plurality of generated messages;
setting a reminder to notify the user of a callback, wherein a type of reminder is based on the selected message; and
transmitting the selected message to a device where the incoming call originated.

20. The computer readable medium of claim 19, wherein status information is based on at least one of a time of day, a location of a user device, and a speed at which a user device is changing location, and wherein the reminder comprises one of setting a reminder on one of a reminder app or a calendar app, setting a geo-fence around a specified location, or setting a countdown time to the time of notification.
